(19) United States
(12) Patent Application Publication
(10) Pub. No.: US 2025/0177916 A1
(43) Pub. Date: Jun. 5, 2025

(54) HYDROGEN PURIFICATION SYSTEM AND CONTROL METHOD THEREOF

(71) Applicant: Industrial Technology Research Institute, Hsinchu (TW)

(72) Inventors: Yin-Wen Tsai, Hsinchu County (TW); Hong-Bao Chang, Miaoli County (TW); Ku-Yen Kang, Hsinchu County (TW); Chun-Ho Tai, Hsinchu City (TW); Li-Duan Tsai, Hsinchu City (TW)

(73) Assignee: Industrial Technology Research Institute, Hsinchu (TW)

(21) Appl. No.: 18/391,669

(22) Filed: Dec. 21, 2023

(30) Foreign Application Priority Data
Nov. 30, 2023 (TW) 112146567

(51) Int. Cl. B01D 53/32; B01D 53/30; C01B 3/50

(52) U.S. Cl. CPC B01D 53/326; B01D 53/30; C01B 3/50; B01D 2257/102; B01D 2257/502; B01D 2257/504; C01B 2203/047; C01B 2203/0475

(57) ABSTRACT

Disclosed are a hydrogen purification system and a control method thereof. The hydrogen purification system includes a hydrogen purification module, a control unit, and a pressure control unit. The control unit is coupled to the pressure control unit, and the pressure control unit is connected to an anode gas outflow path of the hydrogen purification module. The control method includes the following steps. First, providing a mixed gas including hydrogen to the hydrogen purification module. Secondly, providing an electric power to the hydrogen purification module to perform an oxidation-reduction reaction of hydrogen. After that, utilizing the pressure control unit to instantly increase and decrease a pressure of an anode in the hydrogen purification module, wherein the control unit controls opening and closing of the pressure control unit. An instantaneous increase in the pressure of the anode in the hydrogen purification module is higher than or equal to 0.04 bar.

### CROSS-REFERENCE TO RELATED APPLICATION

This application claims the priority benefit of Taiwan application serial no. 112146567, filed on Nov. 30, 2023. The entirety of the above-mentioned patent application is hereby incorporated by reference herein and made a part of this specification.

### TECHNICAL FIELD

The present disclosure relates to a hydrogen purification system and a control method thereof.

### BACKGROUND

When utilizing a hydrogen purification module to perform an electrochemical reaction to separate or purify hydrogen in a mixed gas, the remaining gas in the mixed gas that does not participate in the electrochemical reaction is likely to remain in a flow path of the anode; or the humidified water vapor in the mixed gas might condense in the flow path of the anode, all of the above make it more likely to prevent hydrogen in the mixed gas from diffusing to the porous carbon electrode and/or reduce the reaction sites on the porous carbon electrode, thus affecting the oxidation reaction of hydrogen in the anode. Therefore, the efficiency of the hydrogen purification module in purifying hydrogen will be reduced.

### SUMMARY

The present disclosure provides a control method for a hydrogen purification system. In the control method of the hydrogen purification system according to an embodiment of the present disclosure, the hydrogen purification system includes a hydrogen purification module, a control unit and a pressure control unit. The control unit is coupled to the pressure control unit, and the pressure control unit is connected to an anode gas outflow path of the hydrogen purification module, wherein the control method includes the following steps. First, a mixed gas including hydrogen is provided to the hydrogen purification module. Then, an electric power is provided to the hydrogen purification module to perform an oxidation-reduction reaction of hydrogen. Afterwards, the pressure control unit is utilized to instantly increase and decrease the pressure of the anode in the hydrogen purification module, wherein the control unit controls the opening and closing of the pressure control unit. An instantaneous increase in the pressure of the anode in the hydrogen purification module is higher than or equal to 0.04 bar.

The present disclosure provides a hydrogen purification system. The hydrogen purification system according to an embodiment of the present disclosure includes a hydrogen purification module, a pressure control unit and a control unit. The hydrogen purification module includes a plurality of membrane-electrode assemblies, and one of the plurality of membrane-electrode assemblies includes an anode, a cathode, and a proton exchange membrane. The pressure control unit is connected to an anode gas outflow path of the hydrogen purification module, and may be disposed to instantly increase and decrease the pressure of the anode in the hydrogen purification module, wherein when the pressure of the anode in the hydrogen purification module increases instantly, the instantaneous increase in pressure of the anode is higher than or equal to 0.04 bar. The control unit is coupled to the pressure control unit, wherein the control unit may be utilized to control the actuation of the pressure control unit.

### BRIEF DESCRIPTION OF THE DRAWINGS

FIG. 1 is a schematic diagram of a hydrogen purification system according to an embodiment of the present disclosure.

FIG. 2 is a flow chart of a control method of a hydrogen purification system according to an embodiment of the present disclosure.

FIG. 3A is a graph showing the relationship between the pressure of the anode and time when operating the hydrogen purification module of Example 1.

FIG. 3B is a graph showing the relationship between the pressure of the anode and time when operating the hydrogen purification module of Comparative Example 1.

FIG. 4A is a graph showing the relationship between the reaction current of the hydrogen purification module and time when operating the hydrogen purification module of Example 1.

FIG. 4B is a graph showing the relationship between the reaction current of the hydrogen purification module and time when operating the hydrogen purification module of Comparative Example 1.

FIG. 5 is a graph showing the relationship between voltage of each membrane-electrode assembly in the hydrogen purification module and time when operating the hydrogen purification module of Example 1.

FIG. 6A is a graph showing the relationship between the pressure of the anode and time when operating the hydrogen purification modules of Example 1, Example 5 and Example 6 respectively.

FIG. 6B is a graph showing the relationship between the reaction current of the hydrogen purification module and time when operating the hydrogen purification modules of Example 1, Example 5 and Example 6 respectively.

### DETAILED DESCRIPTION OF DISCLOSED EMBODIMENTS

The present disclosure can be understood by referring to the following detailed description and combined with the accompanying drawings. It should be noted that, in order to make the readers easy to comprehend and make the drawings to be concise, many of the drawings in the present disclosure only depict part of the electronic device, and certain elements in the drawings are not drawn to actual scale. In addition, the number and size of elements in the figures are only for illustration and are not intended to limit the scope of the present disclosure.

The directional terms mentioned in this disclosure, such as “up”, “down”, “front”, “back”, “left”, “right”, etc., are only for reference to the directions of the accompanying drawings. Accordingly, the directional terms used are illustrative and not limiting of the disclosure. In the drawings, each figure illustrates the general features of methods, structures, and/or materials used in particular embodiments. However, these drawings should not be interpreted as defining or limiting the scope or nature encompassed by these embodiments. For example, the relative sizes, thicknesses, and locations of various layers, regions, and/or structures may be reduced or exaggerated for clarity.

The terms “about”, “equal to”, “equivalent to” or “the same”, “substantially” or “roughly” are normally interpreted to mean a range within 20% of a given value or range, or to mean a range within 10%, 5%, 3%, 2%, 1% or 0.5% of a given value or range.

It should be noted that the following embodiments may be replaced, reorganized, and mixed with features in several different embodiments without departing from the spirit of the present disclosure to complete other embodiments. Features in various embodiments may be mixed and matched with each other as long as they do not violate the spirit of the disclosure or conflict with each other.

The following are examples of exemplary embodiments of the present disclosure. The same reference symbols are adopted in the drawings and descriptions to represent the same or similar parts.

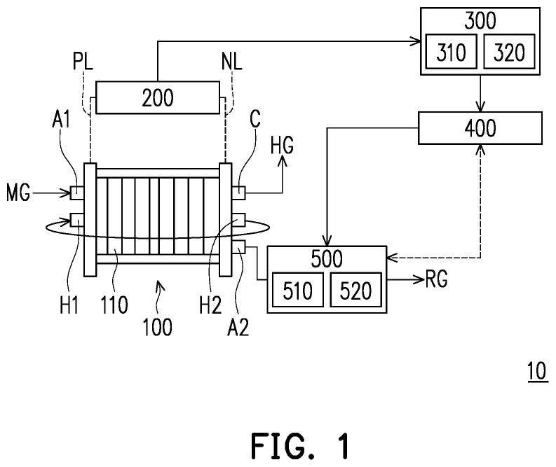

FIG. 1 is a schematic diagram of a hydrogen purification system according to an embodiment of the present disclosure.

Please refer to FIG. 1. In some embodiments, the hydrogen purification system 10 of this embodiment may include a hydrogen purification module 100, an anode gas inflow path A1, an anode gas outflow path A2, a cathode gas outflow path C, a heat exchange medium inflow path H1, a heat exchange medium outflow path H2, a power supply unit 200, an electrical measurement unit 300, a control unit 400 and a pressure control unit 500. However, the elements included in the hydrogen purification system 10 of the present disclosure are not limited thereto.

In some embodiments, the hydrogen purification system 10 may also include a humidifier (not shown). The humidifier is connected to the anode gas inflow path A1, for example, to humidify the mixed gas MG before the mixed gas MG flows into the hydrogen purification module 100, but the disclosure is not limited thereto.

The hydrogen purification module 100 may be, for example, an electrochemical hydrogen purification (EHP) stack. For example, after the hydrogen purification module 100 receives a mixed gas MG containing hydrogen on anode side, the hydrogen in the mixed gas MG may be separated and transported from anode side of the hydrogen purification module 100 to the cathode side for collection through an electrochemical reaction. The remaining gas RG in the mixed gas MG is discharged out of the hydrogen purification module 100, for example, to achieve purification of hydrogen. In detail, the hydrogen purification module 100 may, for example, include a plurality of membrane-electrode assemblies 110, wherein each membrane-electrode assembly 110 may be regarded as a reaction unit. One of the plurality of membrane-electrode assemblies 110 may include, for example, a proton exchange membrane, an anode, and a cathode. In some embodiments, a plurality units of membrane-electrode assemblies 110 may be stacked and connected in series, or a plurality units of membrane-electrode assemblies 110 may be connected in parallel to form the hydrogen purification module 100, but the present disclosure is not limited thereto.

The proton exchange membrane is, for example, disposed between the anode and the cathode, and the proton exchange membrane may be used to suppress circulation of electrons or impurities and/or pollutants (such as from mixed gas MG) between the anode and the cathode on the circumstances of not hindering the penetration of protons as charge carriers. In some embodiments, the proton exchange membrane may include polymer materials, which may include hydrocarbon-based polymers, fluorine-containing polymers, or other suitable polymers or combinations thereof, but the present disclosure is not limited thereto.

In this embodiment, the anode is coupled to the anode gas inflow path A1 to receive a mixed gas MG containing hydrogen from the anode inflow path A1. Based on the above, when operating the hydrogen purification module 100, the hydrogen in the mixed gas MG may be oxidized at the anode to generate protons and electrons. The anode may, for example, include a porous carbon electrode, and may also include a catalyst (e.g., platinum) to accelerate the oxidation reaction of hydrogen, but the disclosure is not limited thereto. In some embodiments, the anode may include an anode bipolar plate having a flow path for the mixed gas MG to flow. Additionally, in some embodiments, the anode may further include an anode porous diffusion plate, which may, for example, guide the mixed gas MG to the porous carbon electrode. In this embodiment, when operating the hydrogen purification module 100, the oxidation reaction in the anode may be expressed by the following formula: H₂→2H⁺+2e⁻.

In some embodiments, in addition to hydrogen, the mixed gas MG may further include nitrogen, carbon dioxide, carbon monoxide, other gases, or combinations thereof, but the disclosure is not limited thereto. In this embodiment, the mixed gas MG includes hydrogen and nitrogen. In some embodiments, the volume ratio of hydrogen to nitrogen is 90:10 to 50:50. For example, the volume ratio of hydrogen to nitrogen may be 81.8:18.2, 70:30, 60:40 or 50:50.

In addition, in this embodiment, the anode is further coupled with the anode gas outflow path A2 to discharge the remaining gas RG out of the hydrogen purification module 100 after operating the hydrogen purification module 100. The remaining gas RG may include, for example, nitrogen, carbon dioxide, carbon monoxide, other gases or combinations thereof, and the disclosure is not limited thereto.

In this embodiment, the cathode is coupled to the cathode gas outflow path C to deliver the hydrogen gas HG generated from the cathode to the outside for collection through the cathode gas outflow path C, and the hydrogen gas HG may, for example, be delivered to a hydrogen storage unit (not shown), but this disclosure is not limited thereto. In detail, protons generated by oxidation of hydrogen in the anode may be reduced to hydrogen in the cathode, for example, by passing through a proton exchange membrane. In some embodiments, the hydrogen gas generated in the cathode may be compressed, but the present disclosure is not limited thereto. The cathode may also include, for example, a porous carbon electrode, and may further include a catalyst (such as platinum) to accelerate the reduction reaction of hydrogen, but the disclosure is not limited thereto. In some embodiments, the cathode may include a cathode bipolar plate having a flow path for hydrogen gas HG to flow. Additionally, in some embodiments, the cathode may further include a cathode porous diffusion plate, which may, for example, guide hydrogen gas HG to the cathode bipolar plate. In this embodiment, when operating the hydrogen purification module 100, the reduction reaction in the cathode may be expressed by the following formula: 2H⁺+2e⁻→H₂.

In some embodiments, the hydrogen purification system 10 may further include a heat exchange medium inflow path H1 and a heat exchange medium outflow path H2. The heat exchange medium inflow path H1 and the heat exchange medium outflow path H2 each are, for example, coupled to the hydrogen purification module 100, wherein the heat exchange medium may flow into the hydrogen purification module 100 through the heat exchange medium inflow path H1, and flow out from the heat exchange medium outflow path H2 through the flow path formed between the anode bipolar plate and the cathode bipolar plate in the hydrogen purification module 100. In some embodiments, the hydrogen purification system 10 may further include a heat exchange medium unit (not shown), and the heat exchange medium unit, the heat exchange medium inflow path H1, the flow path in the hydrogen purification module 100 and the heat exchange medium outflow path H2 may form a closed loop path, but the disclosure is not limited thereto. The heat exchange medium provided by the heat exchange medium unit may, for example, allow the oxidation reaction and reduction reaction of hydrogen in the hydrogen purification module 100 to be carried out at an appropriate temperature, so as to improve the efficiency of purifying hydrogen. In some embodiments, the heat exchange medium unit may include a water circulation pump, and the heat exchange medium may include water, but the disclosure is not limited thereto.

The power supply unit 200 is, for example, coupled to the anode and cathode of the hydrogen purification module 100. In this embodiment, the power supply unit 200 may be electrically connected to the anode and the cathode through the positive electrode power line PL and the negative electrode power line NL, but the disclosure is not limited thereto. The power supply unit 200 may, for example, include any suitable power supply element. For example, the power supply unit 200 may include a power supply source (not shown) and a power conversion unit (not shown). The power supply source may, for example, be utilized to provide power to the hydrogen purification module 100 to perform oxidation-reduction reaction of hydrogen, and the power conversion unit may, for example, include a DC to AC converter, an AC to DC converter or a DC to DC converter to, for example, convert power from a power supply source, but this disclosure is not limited thereto.

The electrical measurement unit 300 is coupled to the power supply unit 200, for example. In this embodiment, the electrical measurement unit 300 includes a current measurement unit 310 and a voltage measurement unit 320. The current measurement unit 310 may be utilized, for example, to measure the total current of the plurality of membrane-electrode assemblies 110 when operating the hydrogen purification module 100, and the voltage measurement unit 320 may be utilized, for example, to measure the voltage of each membrane-electrode assembly 110 when operating the hydrogen purification module 100. In some embodiments, the current measurement unit 310 and the voltage measurement unit 320 may each include appropriate current measurement element and voltage measurement element, but the present disclosure is not limited thereto.

The control unit 400 is coupled to the electrical measurement unit 300 and the pressure control unit 500, for example. In this embodiment, the control unit 400 includes a programmable logic controller (PLC). In detail, the control unit 400 may include, for example, a processing unit, a memory unit and an input/output unit, but the disclosure is not limited thereto. The processing unit may, for example, be utilized to process signals (i.e., the current value measured by the current measurement unit 310 and the voltage value of the voltage measurement unit 320 when the hydrogen purification module 100 is operated) provided by the electrical measurement unit 300, and generate corresponding control signals to the control unit 400. For example, according to this signal to determine the subsequent operation mode of the hydrogen purification module 100. The memory unit may, for example, be utilized to store the above-mentioned signals provided by the electrical measurement unit 300 and/or the signals processed by the processing unit. The input/output units may, for example, respectively receive the above-mentioned signals provided by the electrical measurement unit 300 and output the control signals generated by the processing unit. In the embodiment, the control unit 400 may determine whether the total current of the plurality of membrane-electrode assemblies 110 is lower than a preset current value and/or whether the voltage in at least one membrane-electrode assembly 110 is higher than a preset voltage value. In detail, the preset current values of the plurality of membrane-electrode assemblies 110 may be stored in the memory unit of the control unit 400, and the current values measured by the current measurement unit 310 may be compared with the preset current value of the plurality of membrane-electrode assemblies 110 to make judgment. Similarly, the preset voltage value of the membrane-electrode assembly 110 may be stored in the memory unit of the control unit 400, and the voltage values measured by the voltage measurement unit 320 may be compared with the preset voltage value of the plurality of membrane-electrode assemblies 110 to make judgment.

In some embodiments, the hydrogen purification system 10 may further include a control logic unit (not shown), wherein the control logic unit may be disposed inside or outside the control unit 400. When the control logic unit is disposed outside the control unit 400, the control logic unit may be coupled to the control unit 400 and the pressure control unit 500. The control unit 400 may, for example, control the pressure control unit 500 through a control logic unit, so that the pressure control unit 500 may perform corresponding operations.

The pressure control unit 500 is connected to the anode gas outflow path A2, for example. The pressure control unit 500 may be disposed in the anode gas outflow path A2, for example, to control and improve the environment of the anode of the plurality of membrane-electrode assemblies 110 in the hydrogen purification module 100, for example. In detail, the environment of the anode of the membrane-electrode assembly 110 may have the following conditions, for example. For instance, when operating the hydrogen purification module 100, remaining gas RG that does not participate in the oxidation reaction performed in the porous carbon electrode of the anode may be retained in the flow path of the anode bipolar plate, which makes it more likely to prevent the hydrogen in the mixed gas MG that subsequently enters the anode gas inflow path A1 from being diffused to the porous carbon electrode and/or reduces the reaction sites on the porous carbon electrode, thus affecting the efficiency of the oxidation reaction of hydrogen in the anode. Alternatively, when operating the hydrogen purification module 100, the water vapor in the mixed gas MG and humidified by the humidifier may condense in the flow path in the anode bipolar plate and block the flow path, which also makes it more likely to prevent the hydrogen in the mixed gas MG that subsequently enters the anode gas inflow path A1 from being diffused to the porous carbon electrode, and affects the efficiency of carrying out the oxidation reaction of hydrogen in the anode.

In order to solve the above-mentioned problems that occur when operating the hydrogen purification module 100, this embodiment couples the control unit 400 with the pressure control unit 500, and utilizes the control unit 400 to control the opening and closing of the pressure control unit 500 to improve the environment of the anode of the plurality of membrane-electrode assemblies 110.

In detail, in this embodiment, the pressure control unit 500 is disposed in the anode gas outflow path A2, and the pressure control unit 500 includes a pressure control element 510 and a pressure sensing element 520. The pressure control unit 500 may, for example, receive a signal from the control unit 400 to control the pressure of the anode in the hydrogen purification module 100. For example, the pressure control element 510 in the pressure control unit 500 may be turned on according to a signal from the control unit 400 to reduce the flow rate of the remaining gas RG flowing out through the anode gas outflow path A2, thereby making the pressure on the anode gas outlet side of the hydrogen purification module 100 to increase instantly. Moreover, the pressure sensing element 520 in the pressure control unit 500 may provide pressure information sensed from the anode gas outlet side of the hydrogen purification module 100 to the control unit 400, thereby monitoring the pressure on the anode gas outlet side of the hydrogen purification module 100. In detail, after the pressure on the anode gas outlet side of the hydrogen purification module 100 increases instantly, the pressure control unit 500 may feed back information regarding increase of the pressure to the control unit 400, so that the control unit 400 issues a signal to reduce the pressure of the anode in the hydrogen purification module 100 to the original pressure, and the pressure control element 510 in the pressure control unit 500 may be turned off according to this signal from the control unit 400. In some embodiments, the pressure control element 510 may include a reducer, a control valve, or other suitable pressure control elements, but the present disclosure is not limited thereto.

Based on the above, when the flow path in the anode bipolar plate is blocked due to the retention of remaining gas RG and/or the condensation of water vapor, the current and/or the voltage in the membrane-electrode assembly 110 in the hydrogen purification module 100 will change, wherein the total current in the plurality of membrane-electrode assemblies 110 will be lower than the preset current value and/or the voltage in at least one membrane-electrode assembly 110 will be higher than the preset voltage value. When the electrical measurement unit 300 measures the information regarding the above-mentioned changing current value and/or voltage value, the control unit 400 may respond to the signal and control the pressure control unit 500, so that the pressure control element 510 in the pressure control unit 500 is actuated to reduce the flow rate of the remaining gas RG flowing out through the anode gas outflow path A2. As a result, the pressure on the anode gas outlet side of the hydrogen purification module 100 increases instantly, thereby clearing at least part of the remaining gas RG and/or water vapor retained in the flow path. In this way, the efficiency of the hydrogen purification module 100 in purifying hydrogen may be improved. In addition, the pressure control unit 500 may subsequently feed back the information regarding increase of pressure to the control unit 400, so that the control unit 400 issues a signal to reduce the pressure on the anode gas outlet side of the hydrogen purification module 100 to the original pressure, and the pressure control element 510 in the pressure control unit 500 may receive the control signal from the control unit 400 and be turned off, so that the pressure on the anode gas outlet side of the hydrogen purification module 100 drops to the original pressure.

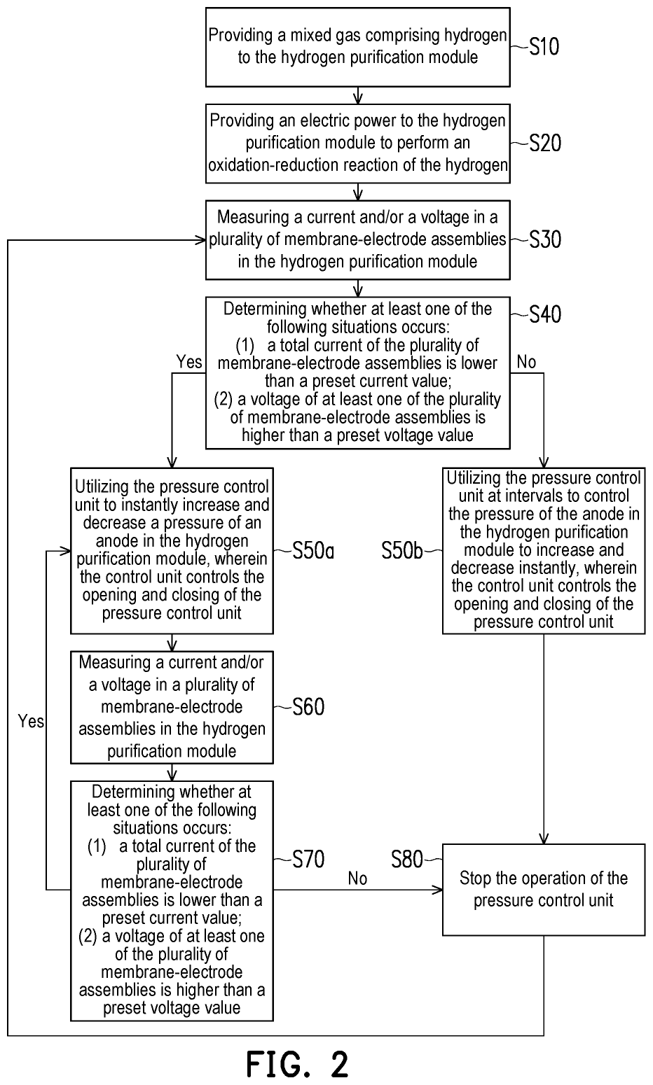

FIG. 2 is a flow chart of a control method of a hydrogen purification system according to an embodiment of the present disclosure. It is worth noting that the hydrogen purification module described in FIG. 2 is exemplified by the above-mentioned hydrogen purification system 10, but it should be noted that the present disclosure is not limited thereto.

Referring to FIG. 2, the control method of the hydrogen purification system of this embodiment includes the following steps.

First, in step S10, the mixed gas MG including hydrogen is provided to the hydrogen purification module 100. The mixed gas MG may be provided to the plurality of membrane-electrode assemblies 110 in the hydrogen purification module 100, for example, through the anode gas inflow path A1 connected to the hydrogen purification module 100. The mixed gas MG may, for example, include hydrogen and other gases other than hydrogen, wherein the other gases may include nitrogen, carbon dioxide, carbon monoxide, other gases or combinations thereof, and the present disclosure is not limited thereto. Description of the elements and functions of the hydrogen purification module 100 may be derived from the above embodiments, and will not be described again here.

It is worth noting that before step S10 is performed, each element in the hydrogen purification system 10 may be turned on sequentially to complete the standby preparations before operating the hydrogen purification module 100. In addition, in some embodiments, the heat exchange medium unit may be activated to regulate the temperature of the hydrogen purification module 100, thereby improving the efficiency of oxidation-reduction reaction of hydrogen.

Then, in step S20, electric power is provided to the hydrogen purification module 100 to perform the oxidation-reduction reaction of hydrogen. In this embodiment, the hydrogen purification system 10 further includes a power supply unit 200, so that electric power may be provided to the plurality of membrane-electrode assemblies 110 in the hydrogen purification module 100 through the power supply unit 200. Description of the elements and functions of the power supply unit 200 may be derived from the above-mentioned embodiments, and will not be described again here.

It is worth mentioning that in step S20, an oxidation reaction of hydrogen will occur in the anode of the hydrogen purification module 100, and a reduction reaction of hydrogen will occur in the cathode of the hydrogen purification module 100, and the remaining gas RG in the mixed gas MG may be discharged from the anode gas outflow path A2 connected to the hydrogen purification module 100 to achieve the effect of purifying hydrogen. Details may be derived from the above embodiments and will not be described again here.

Next, in step S30, the current and/or voltage in the membrane-electrode assembly 110 in the hydrogen purification module 100 is measured. In this embodiment, the hydrogen purification system 10 further includes an electrical measurement unit 300, so the current and/or voltage in the membrane-electrode assembly 110 in the hydrogen purification module 100 may be measured through the electrical measurement unit 300. Description of the elements and functions of the electrical measurement unit 300 may be derived from the above embodiments, and will not be described again here.

Then, in step S40, it is determined whether at least one of the following situations occurs: (1) the total current in the plurality of membrane-electrode assemblies 110 is lower than a preset current value; (2) the voltage in at least one membrane-electrode assembly 110 is higher than a preset voltage value.

In this embodiment, the hydrogen purification system 10 further includes a control unit 400. Therefore, the control unit 400 may be used to determine whether the total current in the plurality of membrane-electrode assemblies 110 is lower than a preset current value and to determine whether the voltage in at least one membrane-electrode assembly 110 is higher than a preset voltage value. In detail, the preset current values of the plurality of membrane-electrode assemblies 110 may be stored in the control unit 400, and the total current in the plurality of membrane-electrode assemblies 110 measured by the current measurement unit 310 may be compared with the preset current value to make judgment. Similarly, the preset voltage value of the plurality of membrane-electrode assemblies 110 may be stored in the control unit 400, and the voltage values measured by the voltage measurement unit 320 may be compared with the preset voltage value of the plurality of membrane-electrode assemblies 110 to make judgment. Description of the elements and functions of the control unit 400 may be derived from the above embodiments, and will not be described again here.

Then, based on the result of determining whether at least one of the above situations (1) and (2) occurs, it is decided to proceed to step S50a or step S50b.

When at least one of the above situations (1) and (2) occurs, step S50a is performed, and the pressure control unit 500 is utilized to instantly increase and decrease the pressure of the anode in the hydrogen purification module 100, wherein the control unit 400 controls the opening and closing of the pressure control unit 500. In this embodiment, the hydrogen purification system 10 further includes a pressure control unit 500. Therefore, the pressure control unit 500 may be operated to reduce the flow rate of the remaining gas RG flowing out through the anode gas outflow path A2, thereby making the pressure of the anode in the hydrogen purification module 100 increase instantly. Description of the elements and functions of the pressure control unit 500 may be derived from the above-mentioned embodiments, and will not be described again here. In some embodiments, the pressure control unit 500 may be used to reduce the flow rate of the remaining gas RG flowing out through the anode gas outflow path A2 according to the following conditions, but the present disclosure is not limited thereto.

For example, due to blockage in the flow path in the anode bipolar plate caused by retention of remaining gas RG and/or condensed water vapor and so on, the current and/or the voltage in the membrane-electrode assembly 110 in the hydrogen purification module 100 will change. In detail, the total current in the plurality of membrane-electrode assemblies 110 will be lower than the preset current value and/or the voltage in at least one membrane-electrode assembly 110 will be higher than the preset voltage value. When the total current in the plurality of membrane-electrode assemblies 110 measured by the electrical measurement unit 300 is lower than the preset current value and/or the voltage in at least one membrane-electrode assembly 110 is higher than the preset voltage value, the control unit 400 may provide a control signal based on this information to control the pressure control unit 500, so that the pressure control element 510 in the pressure control unit 500 is able to reduce the flow rate of the remaining gas RG flowing out through the anode gas outflow path A2. Therefore, the pressure of the anode in the hydrogen purification module 100 may increase instantly, thereby removing at least part of the remaining gas RG and/or water vapor retained in the flow path.

In some embodiments, the preset current value is 70% to 95% of the maximum total reaction current of the hydrogen purification module 100, and the preset voltage value is 0.15V to 0.30V. In this embodiment, the preset current value is 90% of the maximum total reaction current of the hydrogen purification module 100, and the preset voltage value in the membrane-electrode assembly 110 is 0.2V.

In some embodiments, after the pressure control element 510 reduces the flow rate of the remaining gas RG flowing out through the anode gas outflow path A2, the pressure of the anode in the hydrogen purification module 100 increases instantly, and it may be controlled that the amount of increase is higher than or equal to 0.04 bar (lower limit value). It is worth noting that when the instantaneous increase in pressure of the anode is lower than 0.04 bar (lower limit value), it may be difficult to remove at least part of the remaining gas RG and/or water vapor retained in the flow path. In other words, when the amount of instantaneous increase in pressure on the anode gas outlet side exceeds 0.04 bar (lower limit value), it is possible to achieve the effect of removing at least part of the remaining gas RG and/or water vapor retained in the flow path. The higher the amount of pressure increase, the better the effect, for example, higher than 0.08 bar, as long as the amount of pressure increase does not cause the proton exchange membrane to rupture. For example, the amount of pressure increase may be controlled in the range of 0.04 bar to 1.2 bar. When the amount of instantaneous increase in the pressure of the anode is higher than 1.2 bar (upper limit value), the proton exchange membrane disposed between the anode and the cathode might not be able to bear the pressure. It is worth noting that the upper limit value of the amount of instantaneous increase in pressure of the anode may, for example, depend on the material type and/or thickness of the proton exchange membrane. For instance, when the material of the proton exchange membrane is a fluorine-containing polymer and the thickness thereof is 15 microns, the amount of instantaneous increase in pressure is controlled to be not higher than 1.2 bar, or, when the material of the proton exchange membrane is fluorine-containing polymer and the thickness thereof is 125 microns, the amount of instantaneous increase in pressure must be controlled to be not higher than 2.5 bar.

It is worth noting that after the pressure of the anode in the hydrogen purification module 100 increases instantly, the pressure sensing element 520 may provide pressure information sensed from the anode in the hydrogen purification module 100 to the control unit 400. Afterwards, the control unit 400 may provide another control signal to the pressure control unit 500 based on this pressure information, so that the pressure control element 510 in the pressure control unit 500 restores the flow rate of the remaining gas RG flowing out of the anode gas outflow path A2 to the original flow rate, so that the pressure of the anode in the hydrogen purification module 100 drops to the original pressure value. Then, multiple cycles of instantly increasing and decreasing the pressure of the anode in the hydrogen purification module 100 may be repeated multiple times, wherein the interval between each cycle may be 2 seconds to 15 seconds.

After step S50a is performed, step S60 is then performed to measure the current and/or voltage in the plurality of membrane-electrode assemblies 110 in the hydrogen purification module 100, wherein step S60 may be the same as or similar to step S30, for example, and no further details will be given here.

After that, step S70 is performed to determine whether at least one of the following situations occurs: (1) the total current in the plurality of membrane-electrode assemblies 110 is lower than the preset current value; (2) the voltage in at least one membrane-electrode assembly 110 is higher than a preset voltage value. Step S70 may be the same as or similar to step S40, and will not be described again here.

When performing step S70, if at least one of the above situations (1) and situation (2) occurs, then return to step S50a. Correspondingly, when step S70 is performed, if neither the above situation (1) nor the situation (2) occurs, step S80 is continued to stop the operation of the pressure control unit 500. Specifically, when the total current in the plurality of membrane-electrode assemblies 110 measured by the electrical measurement unit 300 is not lower than the preset current value and the voltage in each membrane-electrode assembly 110 is not higher than the preset value, the control unit 400 may provide a control signal to the pressure control unit 500 based on this information to stop the operation of the pressure control element 510 in the pressure control unit 500. Accordingly, the flow rate of the remaining gas RG flowing out through the anode gas outflow path A2 no longer changes like pulse wave.

It is worth noting that after step S80 is performed, the process may return to step S30.

Correspondingly, after performing step S40, if neither the above situation (1) nor the situation (2) occurs, proceed to step S50b, and the pressure control unit 500 is utilized at intervals to control the pressure of the anode in the hydrogen purification module 100 to increase and decrease instantly, wherein the control unit 400 controls the opening and closing of the pressure control unit 500.

In detail, even if the current and/or voltage in the membrane-electrode assembly 110 in the hydrogen purification module 100 does not change dramatically, the pressure control element 510 in the pressure control unit 500 of this embodiment may also periodically utilize the pressure control unit 500 to control the pressure of the anode in the hydrogen purification module 100 to increase and decrease instantly, so as to regulate the environment of the anode in the hydrogen purification module 100. In some embodiments, the pressure control element 510 in the pressure control unit 500 makes the pressure of the anode in the hydrogen purification module 100 to increase and decrease instantly every 10 minutes to 60 minutes. In this embodiment, the pressure control element 510 in the pressure control unit 500 makes the pressure of the anode in the hydrogen purification module 100 to increase and decrease instantly every 10 minutes.

After performing step S50b, step S80 may be continued to stop the operation of the pressure control unit 500. Descriptions in this regard may be derived from the above embodiments and will not be repeated.

### EXPERIMENTAL EXAMPLE

The present disclosure will be explained below through experimental examples, but these experimental examples are only for illustration and are not intended to limit the scope of the present disclosure.

### Experimental Example 1: Changing the Amount of Instantaneous Increase in Pressure of the Anode in the Hydrogen Purification Module 100

The hydrogen purification module 100 adopted in Experimental Example 1 is an electrochemical hydrogen purification (EHP) stack, and the elements included therein may be as those mentioned in the above embodiments and will not be described again here. In this Experimental Example 1, the mixed gas MG includes hydrogen and nitrogen, wherein the volume ratio of hydrogen to nitrogen was 70:30. In addition, in this experimental example, the operating voltage of the hydrogen purification module 100 was 3.0V, and the maximum total reaction current in the hydrogen purification module 100 was 0.75 A/cm².

### Example 1

In this embodiment, the initial pressure of the anode in the hydrogen purification module 100 was 0.12 bar. Then, the pressure control element 510 in the pressure control unit 500 was utilized to reduce the flow rate of the remaining gas RG flowing out from the anode gas outflow path A2, so that the pressure on the anode gas outlet side in the hydrogen purification module 100 increased, wherein the pressure of the anode in the hydrogen purification module 100 increased instantly from 0.12 bar to approximately 0.298 bar, that is, the amount of instantaneous increase in the pressure on the anode gas outlet side was about 0.178 bar. Thereafter, the original flow rate of the remaining gas RG flowing out from the anode gas outflow path A2 was restored through the pressure control element 510 in the pressure control unit 500, so that the pressure of the anode in the hydrogen purification module 100 dropped from approximately 0.298 bar back to 0.12 bar. In this embodiment, the pressure control element 510 in the pressure control unit 500 made the anode gas outlet side of the hydrogen purification module 100 to undergo 15 cycles of instantaneous increase and decrease in pressure, wherein the interval between each cycle was 5 seconds.

### Example 2

In this embodiment, Example 2 has substantially the same operating conditions as those in Example 1, and the only difference is that the amount of instantaneous increase in pressure on the anode gas outlet side was about 0.161 bar.

### Example 3

In this embodiment, Example 3 has substantially the same operating conditions as those in Example 1, and the only difference is that the amount of instantaneous increase in pressure on the anode gas outlet side was about 0.125 bar.

### Example 4

In this embodiment, Example 4 has substantially the same operating conditions as those in Example 1, and the only difference is that the amount of instantaneous increase in pressure on the anode gas outlet side was about 0.098 bar.

### Comparative Example 1

In Comparative Example 1, Comparative Example 1 has substantially the same operating conditions as those in Example 1, and the only difference is that the amount of instantaneous increase in pressure on the anode gas outlet side was about 0.038 bar.

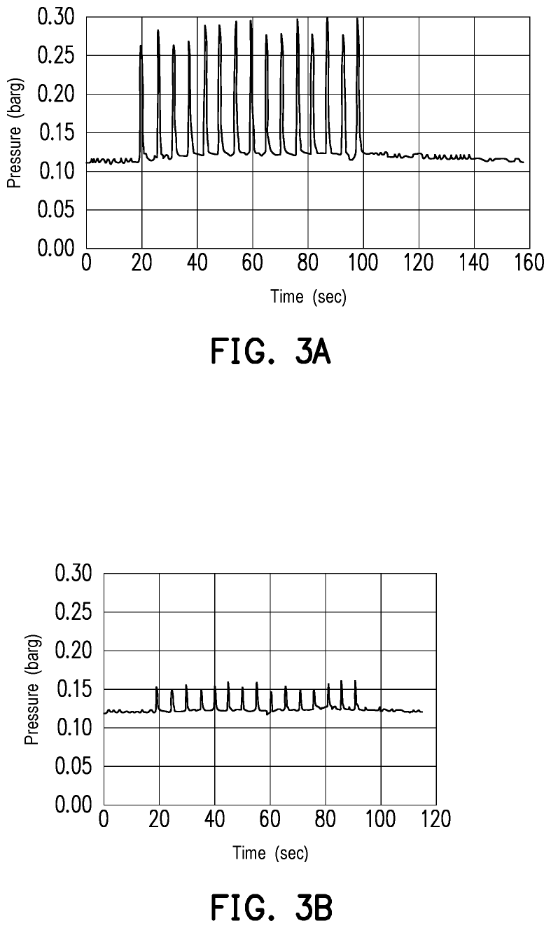

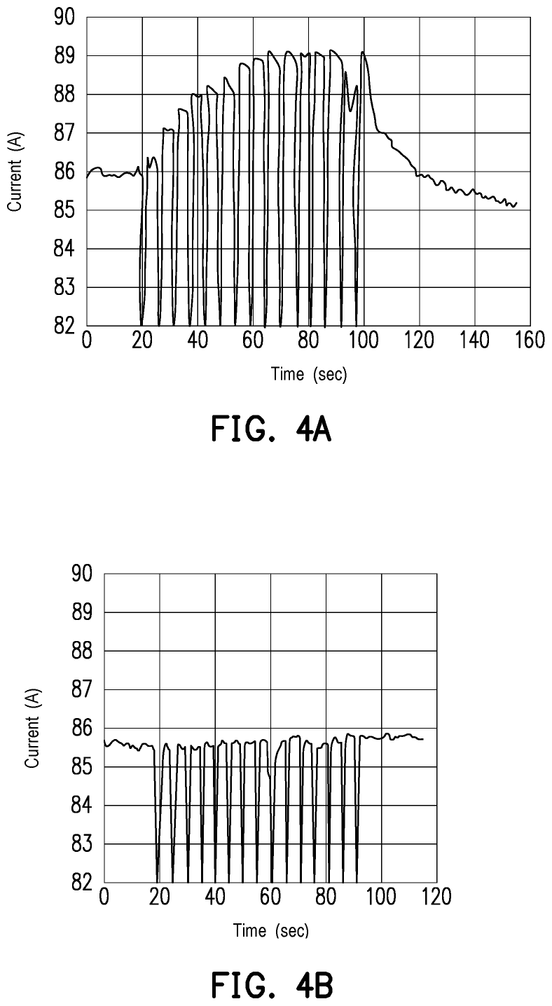

The instantaneous increase in pressure on the anode gas outlet side after the operation of the hydrogen purification module 100 of Example 1 and Comparative Example 1 is shown in FIG. 3A and FIG. 3B, and the amount of increase in reaction current after operation of the hydrogen purification module 100 of Example 1 and Comparative Example 1 is shown in FIG. 4A and FIG. 4B.

As can be seen from FIG. 4A and FIG. 4B, after 15 cycles of instantaneous increase and decrease in pressure, the reaction current of the hydrogen purification module 100 of Example 1 increased from about 86 A to about 89 A, while there was almost no increase in the reaction current of the hydrogen purification module 100 of Comparative Example 1, that is, the hydrogen purification module 100 of Example 1 has better hydrogen purification efficiency than the hydrogen purification module 100 of Comparative Example 1.

Moreover, the amount of increase in reaction current after operation of the hydrogen purification module 100 of Examples 1 to 4 and Comparative Example 1 is summarized in Table 1 below.

TABLE 1

| | Amount of instantaneous | Amount of | Increase in |
|---|---|---|---|
| | increase of pressure | increase in | reaction |
| | on the anode gas outlet | reaction current | current of |
| | side of the hydrogen | of hydrogen | hydrogen |
| | purification module | purification | purification |
| | (bar) | module (A) | module |
| Example 1 | 0.178 | 3.1 | 3.6% |
| Example 2 | 0.161 | 2.5 | 2.9% |
| Example 3 | 0.125 | 1.9 | 2.2% |
| Example 4 | 0.098 | 1 | 1.2% |
| Comparative | 0.038 | 0.4 | 0.5% |
| Example 1 | | | |

As can be seen from the above Table 1, the amount of instantaneous increase in pressure on the anode gas outlet side of the hydrogen purification module 100 is directly proportional to the amount of increase in the reaction current of the hydrogen purification module 100. Therefore, it is possible to expand the amount of instantaneous increase in pressure on the anode gas outlet side of the hydrogen purification module 100 as much as possible without overloading the electrolyte membrane disposed between the anode and cathode, so that the hydrogen purification module 100 is able to have better hydrogen purification efficiency.

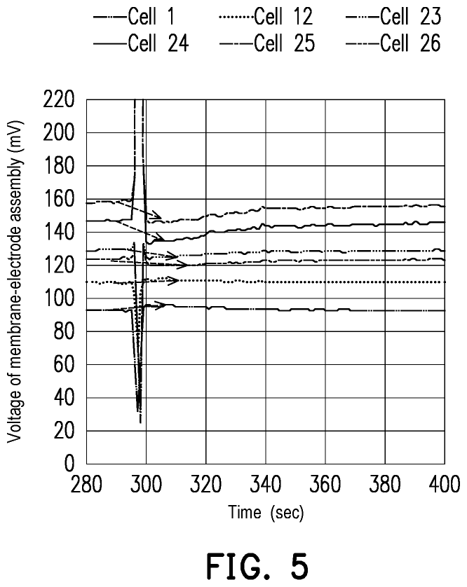

In addition, FIG. 5 shows the change in the voltage of each membrane-electrode assembly 110 in the hydrogen purification module 100 of Example 1 due to the increase in the pressure on the anode gas outlet side, wherein FIG. 5 shows the voltage changes of six membrane-electrode assemblies (Cell 1, Cell 12, Cell 23, Cell 24, Cell 25, Cell 26). It can be seen from FIG. 5 that when the membrane-electrode assembly 110 is dramatically polarized (such as Cell 24 and Cell 25), the operation of increasing the pressure on the anode gas outlet side of the membrane-electrode assembly 110 through the pressure control element 510 in the pressure control unit 500 may effectively alleviate the degree of polarization, so that the hydrogen purification module 100 of Example 1 is able to have better efficiency in purifying hydrogen.

### Experimental Example 2: Changing the Proportion of Hydrogen to Other Gases in the Mixed Gas MG

### Example 5

In this embodiment, Example 5 has substantially the same operating conditions as in Example 1, and the only difference is that the volume ratio of hydrogen to nitrogen was 81.8:18.2.

### Example 6

In this embodiment, Example 6 has substantially the same operating conditions as in Example 1, and the only difference is that the volume ratio of hydrogen to nitrogen was 60:40.

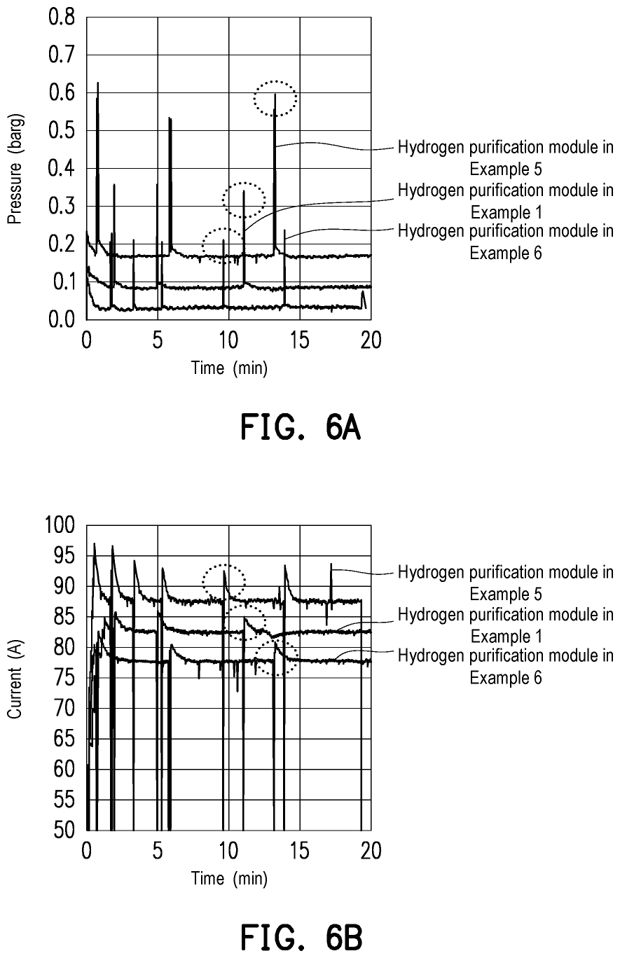

As can be seen from FIG. 6A and FIG. 6B, there are three situations in which the proportions of hydrogen to other gases (nitrogen) in the mixed gas MG are different. The reaction currents of the hydrogen purification modules 100 of Example 1, Example 5 and Example 6 may be increased. That is, the control method of the hydrogen purification module 100 provided in the present disclosure may be applied to different proportions of hydrogen to other gases (nitrogen).

In summary, the present disclosure provides a control method for a hydrogen purification system. When operating a hydrogen purification module, a pressure control unit is utilized to make the pressure of the anode in the hydrogen purification module to increase and decrease instantly, wherein the control unit may periodically control the opening and closing of the pressure control unit or according to the received abnormal signal (for example (1) the total current in multiple membrane-electrode assemblies is lower than the preset current value; or (2) the voltage in at least one membrane-electrode assembly is higher than the preset voltage value), thereby removing at least part of the remaining gas and/or water vapor retained in the flow path of the anode, so that the efficiency of the hydrogen purification module in purifying hydrogen may be improved.

What is claimed is:

1. A control method of a hydrogen purification system, wherein the hydrogen purification system comprises a hydrogen purification module, a control unit, and a pressure control unit, the control unit is coupled to the pressure control unit, and the pressure control unit is connected to an anode gas outflow path of the hydrogen purification module, and the control method comprising:
providing a mixed gas comprising hydrogen to the hydrogen purification module;
providing an electric power to the hydrogen purification module to perform an oxidation-reduction reaction of the hydrogen; and
utilizing the pressure control unit to instantly increase and decrease a pressure of an anode in the hydrogen purification module, wherein the control unit controls an actuation of the pressure control unit,
wherein an instantaneous increase in the pressure of the anode in the hydrogen purification module is higher than or equal to 0.04 bar.

2. The control method of the hydrogen purification system according to claim 1, wherein utilizing the pressure control unit to instantly increase and decrease the pressure of the anode in the hydrogen purification module comprises utilizing the pressure control unit to reduce a flow rate of a remaining gas flowing out from the anode gas outflow path, so that the pressure of the anode in the hydrogen purification module increases instantly, and utilizing the pressure control unit to restore the remaining gas flowing out from the anode gas outflow path to an original flow rate, so that the pressure of the anode in the hydrogen purification module drops to an original pressure.

3. The control method of the hydrogen purification system according to claim 1, wherein following providing the electric power to the hydrogen purification module, the control method further comprises performing at least one cycle as follows:
measuring a current and/or a voltage in a plurality of membrane-electrode assemblies in the hydrogen purification module; and
determining whether at least one of the following situations occurs:
(1) a total current of the plurality of membrane-electrode assemblies is lower than a preset current value;
(2) a voltage of at least one of the plurality of membrane-electrode assemblies is higher than a preset voltage value,
when at least one of the situation (1) and the situation (2) occurs, utilizing the pressure control unit to instantly increase and decrease the pressure of the anode in the hydrogen purification module.

4. The control method of the hydrogen purification system according to claim 3, wherein the preset current value is 70% to 95% of a maximum total reaction current of the plurality of membrane-electrode assemblies, and the preset voltage value is 0.15V to 0.30V.

5. The control method of the hydrogen purification system according to claim 3, wherein when the situation (1) and the situation (2) do not occur, the pressure control unit is utilized at intervals to control the pressure of the anode in the hydrogen purification module to increase and decrease instantly.

6. The control method of the hydrogen purification system according to claim 5, wherein the interval is 10 minutes to 60 minutes.

7. The control method of the hydrogen purification system according to claim 1, wherein the hydrogen purification system further comprises a power supply unit, and the electric power is provided to the hydrogen purification module through the power supply unit.

8. The control method of the hydrogen purification system according to claim 3, wherein the hydrogen purification system further comprises an electrical measurement unit, the electrical measurement unit comprises a current measurement unit and a voltage measurement unit, wherein the total current of the plurality of membrane-electrode assemblies is measured by the current measurement unit, and the voltage of the at least one membrane-electrode assembly is measured through the voltage measurement unit.

9. The control method of the hydrogen purification system according to claim 3, wherein the control unit determines whether the total current of the plurality of membrane-electrode assemblies is lower than the preset current value and/or whether the voltage in the at least one membrane-electrode assembly is higher than the preset voltage value.

10. The control method of the hydrogen purification system according to claim 9, wherein the control unit comprises a programmable logic controller (PLC).

11. The control method of the hydrogen purification system according to claim 2, wherein the pressure control unit comprises a pressure control element and a pressure sensing element, the pressure control element reduces and/or increases the flow rate of the remaining gas flowing out through the anode gas outflow path according to a signal of the control unit, and the pressure sensing element provides pressure information sensed from the anode in the hydrogen purification module to the control unit to monitor the pressure of the anode in the hydrogen purification module.

12. The control method of the hydrogen purification system according to claim 1, wherein the mixed gas further comprises nitrogen, carbon dioxide, carbon monoxide, or a combination thereof.

13. The control method of the hydrogen purification system according to claim 1, wherein the mixed gas further comprises nitrogen, and a volume ratio of the hydrogen to the nitrogen is 90:10 to 50:50.

14. A hydrogen purification system, comprising:
a hydrogen purification module comprising a plurality of membrane-electrode assemblies, wherein one of the plurality of membrane-electrode assemblies comprises an anode, a cathode and a proton exchange membrane;
a pressure control unit connected to an anode gas outflow path of the hydrogen purification module, and disposed to instantly increase and decrease a pressure of the anode in the hydrogen purification module, wherein when the pressure of the anode in the hydrogen purification module increases instantly, an instantaneous increase in the pressure of the anode is higher than or equal to 0.04 bar; and
a control unit coupled to the pressure control unit, wherein the control unit is utilized to control an actuation of the pressure control unit.

15. The hydrogen purification system according to claim 14, further comprising a power supply unit, wherein an electric power is provided to the hydrogen purification module through the power supply unit.

16. The hydrogen purification system according to claim 14, further comprising an electrical measurement unit, wherein the electrical measurement unit comprises a current measurement unit and a voltage measurement unit, wherein the current measurement unit is disposed to measure a total current of the plurality of membrane-electrode assemblies, and the voltage measurement unit is disposed to measure a voltage of the at least one membrane-electrode assembly.

17. The hydrogen purification system according to claim 14, wherein the control unit comprises a programmable logic controller (PLC).

18. The hydrogen purification system according to claim 14, wherein the pressure control unit comprises a pressure control element and a pressure sensing element, the pressure control element reduces and/or increases a flow rate of a remaining gas flowing out through the anode gas outflow path according to a signal of the control unit, and the pressure sensing element is able to sense pressure information of the anode.

19. The hydrogen purification system according to claim 14, further comprising an anode gas inflow path, wherein the anode is coupled with the anode gas inflow path to receive a mixed gas from the anode gas inflow path.

20. The hydrogen purification system according to claim 19, wherein the mixed gas further comprises nitrogen, carbon dioxide, carbon monoxide, or a combination thereof.
